(19) United States
(12) Patent Application Publication
(10) Pub. No.: US 2025/0013930 A1
(43) Pub. Date: Jan. 9, 2025

(54) UNSUPERVISED TIME SERIES OUTLIER DETECTION

(71) Applicant: PayPal, Inc., San Jose, CA (US)

(72) Inventors: Yiheng Zhou, Shanghai (CN); Sneha Venkatachalam, San Jose, CA (US)

(21) Appl. No.: 18/489,474

(22) Filed: Oct. 18, 2023

(30) Foreign Application Priority Data
Jul. 3, 2023 (WO) PCT/CN2023/105526

(51) Int. Cl. G06N 20/20

(52) U.S. Cl. CPC G06N 20/20

(57) ABSTRACT

Techniques are disclosed that relate to identifying a set of outlier data points from a set of time-series data. A computer system may receive time-series data that includes a plurality of data points. The computer system scores, using a first scoring function, a plurality of candidate outlier detection models to evaluate their ability to accurately predict outlier data points in the time-series data. The computer system selects, based on results of the scoring, a selected one of the plurality of candidate outlier detection models that predicts a preliminary set of outlier data points. Weak outliers may be removed and missing outliers added to generate a final set of outlier data points. The computer system may output one or messages explaining the rationale for including one or more of the final set of outlier data points.

### PRIORITY CLAIM

The present application claims priority to PCT Appl. No. PCT/CN2023/105526, entitled “UNSUPERVISED TIME SERIES OUTLIER DETECTION,” filed Jul. 3, 2023, which is incorporated by reference herein in its entirety.

### BACKGROUND

### Technical Field

This disclosure relates generally to computer systems and, more specifically, to various techniques for identifying outlier data points for time-series data.

### Description of the Related Art

Enterprises are increasingly utilizing machine learning to enhance the services that they provide to their users. Using machine learning techniques, a computer system can train models from existing data and then use them to identify similar trends in new data. In some cases, the training process is supervised in which the computer system is provided with labeled data that it can use to train a model. For example, a model for identifying spam can be trained based on emails that are labeled as either spam or not spam. Examples of supervised learning algorithms include linear regression, logistic regression, and support vector machines. In other cases, the training process can be unsupervised in which the computer system is provided with unlabeled data that it can use to train a model to discover underlying patterns in that data. Unsupervised training may be favored in scenarios in which obtaining labeled data is difficult, costly, and/or time-consuming.

### BRIEF DESCRIPTION OF THE DRAWINGS

FIG. 1 is a block diagram of one embodiment of a system having a time-series analysis engine that is capable of predicting outliers from time-series data.

FIG. 2A is a block diagram of one embodiment of a model selection engine that is capable of predicting outliers from time-series data.

FIG. 2B is a block diagram of one embodiment of a model scoring module that is capable of scoring a candidate outlier detection model using a scoring function.

FIG. 2C is a block diagram of one embodiment of a model selection module that is capable of selecting a candidate outlier detection model.

FIG. 3A is a chart illustrating an example of applying moving average window metric to time-series data.

FIG. 3B is a chart illustrating an example of applying spike rate metric to time-series data.

FIG. 3C is a chart illustrating an example of applying outlier distances metric to time-series data.

FIG. 3D is a chart illustrating an example of applying outlier extreme period metric to time-series data.

FIG. 3E is a chart illustrating an example of applying non-outlier extreme period metric to time-series data.

FIG. 3F is a chart illustrating an example of applying similar non-outlier metric to time-series data.

FIG. 4A is a block diagram of one embodiment of a time-series evaluation engine that is capable of filtering outliers to generate a final set of outlier data points.

FIG. 4B is a block diagram of one embodiment of a strong/weak outlier analysis module that is capable of classifying an outlier as strong or weak.

FIG. 4C is a chart illustrating an example of applying strong/weak outlier analysis module to a preliminary set of outlier data points.

FIG. 5A is a block diagram of one embodiment of a missing outlier module that is capable of identifying missing outliers from a set of non-outlier data points.

FIG. 5B is a chart illustrating an example of applying missing outlier module to time-series data.

FIG. 6A is a block diagram of one embodiment of a keyword filter module that is capable of filtering outliers based on keywords.

FIG. 6B is a chart illustrating an example of applying keyword filter module to a preliminary set of strong outliers to generate a final set of outlier data points.

FIG. 7A is a block diagram of one embodiment of a trend identification module that is capable of identifying trends from time-series data.

FIG. 7B is a chart illustrating an example of applying trend identification module to time-series data to generate a set of trend data points.

FIG. 8A is a block diagram of one embodiment of a message engine that is capable of generating narratives about outliers and trends and messaging users.

FIG. 8B depicts an example of an outlier narrative.

FIG. 8C depicts an example of a trend narrative.

FIG. 9 is a flow diagram illustrating one embodiment of a method for predicting outliers from time-series data.

FIG. 10 is a block diagram illustrating elements of a computer system for implementing various systems described in the present disclosure.

### DETAILED DESCRIPTION

In a data-driven world, the ability of data scientists to extract meaningful knowledge from large datasets is crucial for providing insight to an organization's operations. For example, a data scientist may analyze a set of data (e.g., website traffic) to identify peak hours and predict future traffic patterns. One way a data scientist may accomplish this is by acquiring data from various sources (e.g., databases, reports) and developing a machine learning model to identify characteristics within the data. In many cases, the set of data includes time-series data. Time series data is a sequence of data points recorded at regular intervals over some period of time. By analyzing the data points, patterns, trends, and anomalies (e.g., outliers) can be identified using time series analysis techniques or models. As is understood in the art, an outlier is a singular data point that deviates significantly from other data points in a dataset, and a trend is a set of sequential data points that monotonically increase or decrease during some period of time. There are various computer models a data scientist may use (e.g., Prophet) to identify outlier data points that deviate significantly from a majority of data points.

Conventional approaches for outlier identification that are based on machine learning techniques may be deficient for various reasons, however. Conventional outlier detection models are typically dependent on labeled training data. Labeled data refers to a set of data points with meaningful and informative labels used to teach supervised machine learning models. Labeling data may be challenging, costly, and time-consuming when dealing with hundreds of different types of data. Conventional outlier detection models also commonly lack the capability to deal with different types of time-series data, and thus the outlier detection model may behave differently per dataset. Without manual adjustments by a data scientist of the parameters to suit the type of data, the outlier detection model may exhibit high or low sensitivity levels when predicting outliers. An outlier detection model with high sensitivity may classify non-outlier data points as outliers, and an outlier detection model with low sensitivity may only classify a single data point as an outlier despite the dataset having multiple outliers. Manually adjusting the outlier detection model can be time consuming and resource intensive if the same model is used for predicting outliers for a large number of datasets.

The present inventors have recognized these and other shortcomings in the art, and thus propose, among other things, how to select one of a set of candidate outlier detection models for predicting outliers for different types of time-series data, without the need for supervised data (that is, none of the time-series data needs to be labeled). In particular, the present inventors recognize that unsupervised machine learning techniques represent a mechanism that can be used to facilitate the automated selection of an outlier detection model to identify or predict outliers from time-series data.

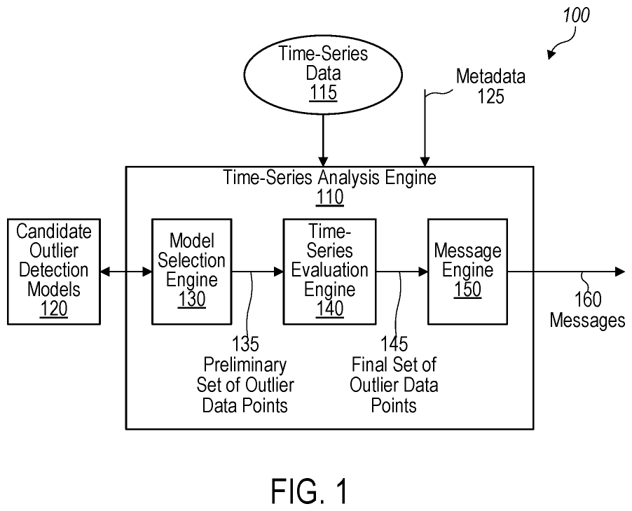

In various embodiments described below, a system comprises a time-series analysis engine for predicting outliers in a set of time-series data, using a set of candidate outlier detection models, and scoring the candidate outlier detection model's performance based on its predicted outliers, using a scoring function. As part of scoring the candidate outlier detection models, in various embodiments, the time-series analysis engine receives time-series data that describes executed computer operations in sequential order (including data points associated with those operations) and a set of candidate outlier detection models for predicting outliers in the dataset. The time-series analysis engine independently applies each candidate outlier detection model to the time-series dataset in which each candidate outlier detection model generates a set of predicted outliers. The time-series analysis engine scores their respective predicted outliers based on a scoring function and selects the candidate model and its associated predicted outliers based on the model score. The set of predicted outliers, in various embodiments, are further identified as strong or weak outliers based on a strong/weak scoring function and are filtered from the set of predicted outliers based on data type keywords and user input. After the final predicted outliers are generated, the time-series analysis engine may provide those outliers to a message engine to provide a narrative to the user, describing the nature of the outlier in the time-series data. An exemplary application of these techniques will now be discussed, starting with reference to FIG. 1.

Turning now to FIG. 1, a block diagram of system 100 is shown. System 100 includes a set of components that may be implemented via hardware or a combination of hardware and software routines. In the illustrated embodiment, system 100 includes a time-series analysis engine 110. As shown, time-series analysis engine 110 includes a model selection engine 130, a time-series evaluation engine 140, and a message engine 150. As further shown, time-series analysis engine 110 receives time-series data 115 and candidate outlier detection models 120. In some cases, the illustrated embodiment may be implemented differently than shown. As an example, time-series analysis engine 110 may not include message engine 150 and messages 160.

System 100, in various embodiments, is a platform that provides one or more services (e.g., a cloud computing service, a customer relationship management service, and a payment processing service) that are accessible to users that can invoke functionality of the services to achieve a user-desired objective. In order to facilitate the functionality of those services, system 100 may execute various software routines, such as time-series analysis engine 110, as well as provide code, web pages, and other data to users, databases, and other entities that use system 100. In various embodiments, system 100 is implemented using a cloud infrastructure that is provided by a cloud provider. Components of time-series analysis engine 110 may thus execute on and utilize the available cloud resources of that cloud infrastructure (e.g., computing resources, storage resources, etc.) to facilitate their operation. As an example, software that is executable to implement functionality of model selection engine 130 may be stored on a non-transitory computer-readable medium of server-based hardware that is included in a datacenter of the cloud provider. That software may be executed within a virtual environment that is hosted on the server-based hardware. In some embodiments, system 100 is implemented using a local or private infrastructure as opposed to a public cloud.

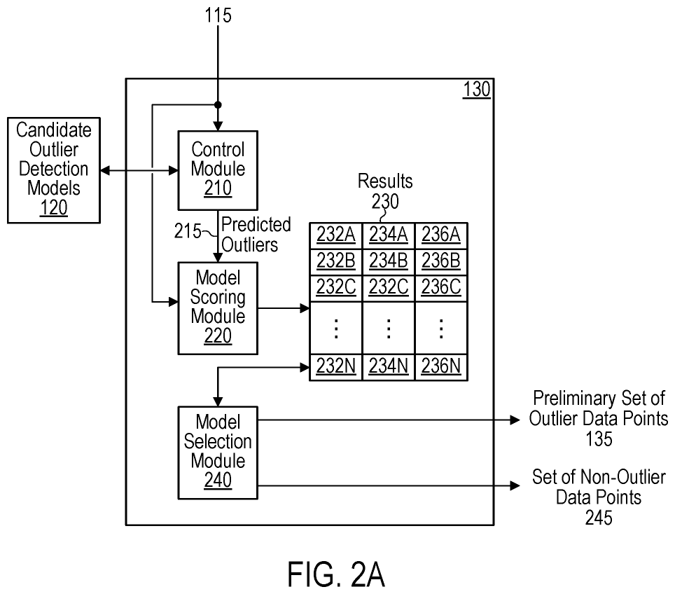

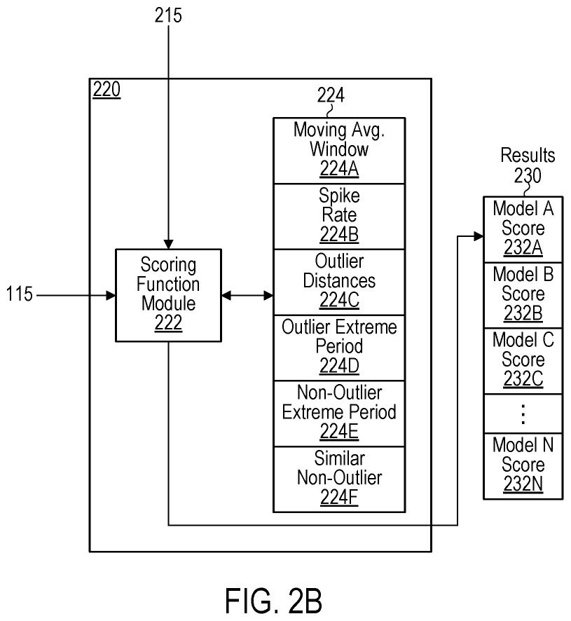

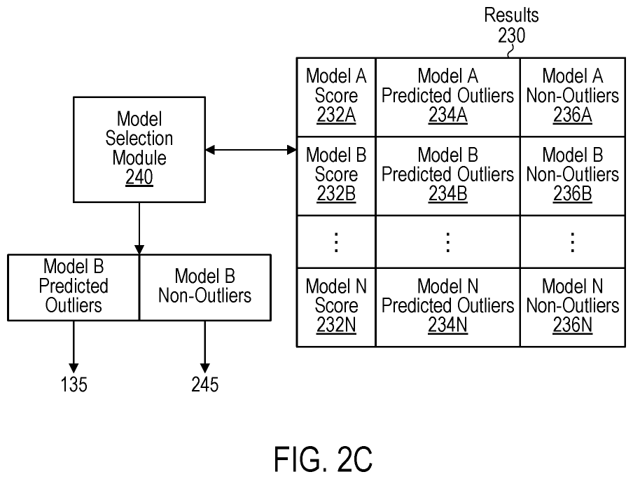

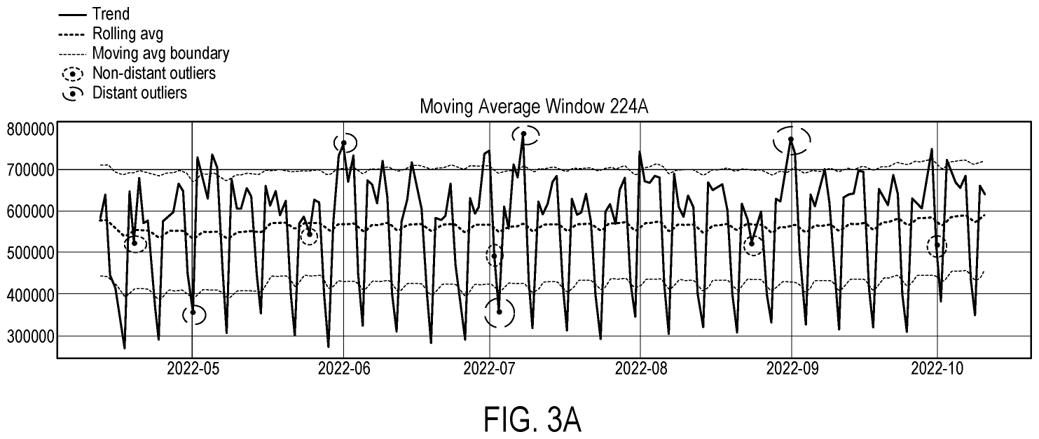

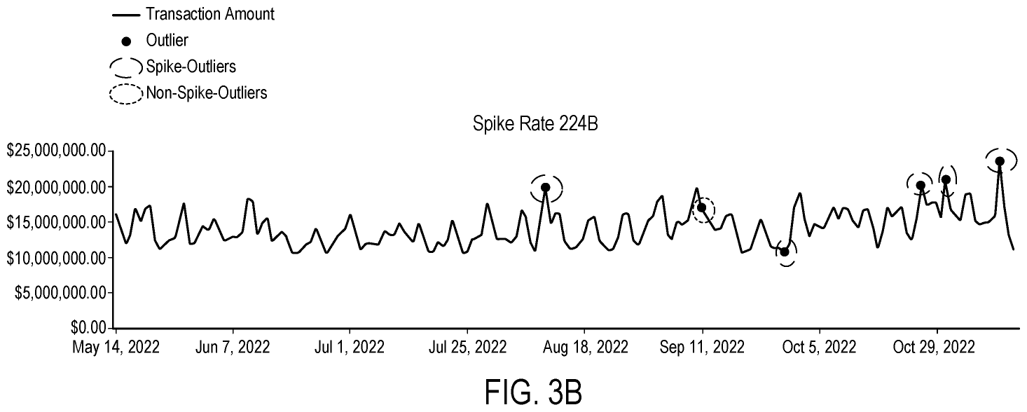

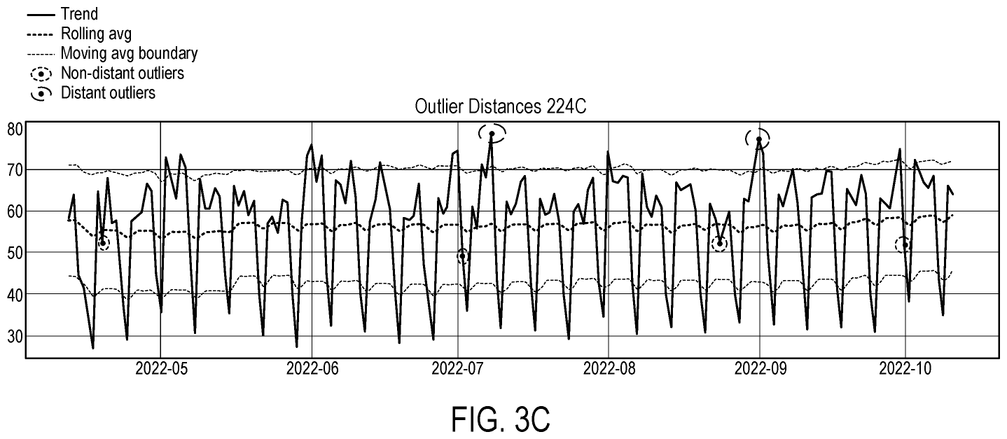

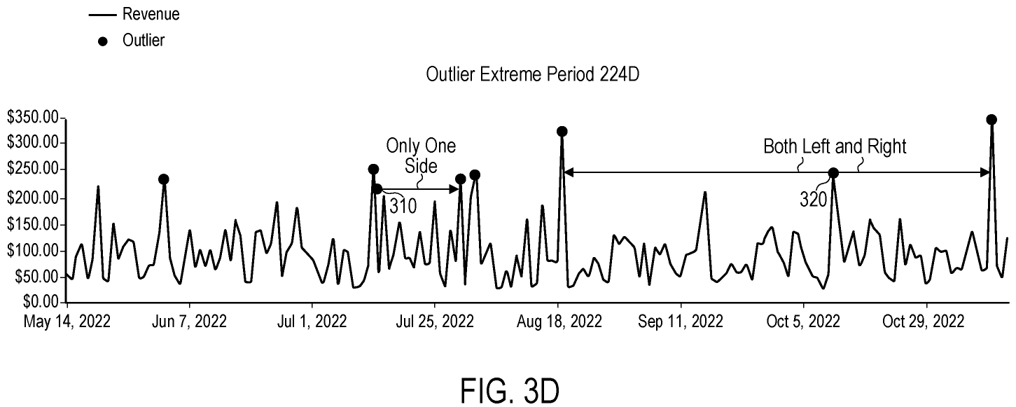

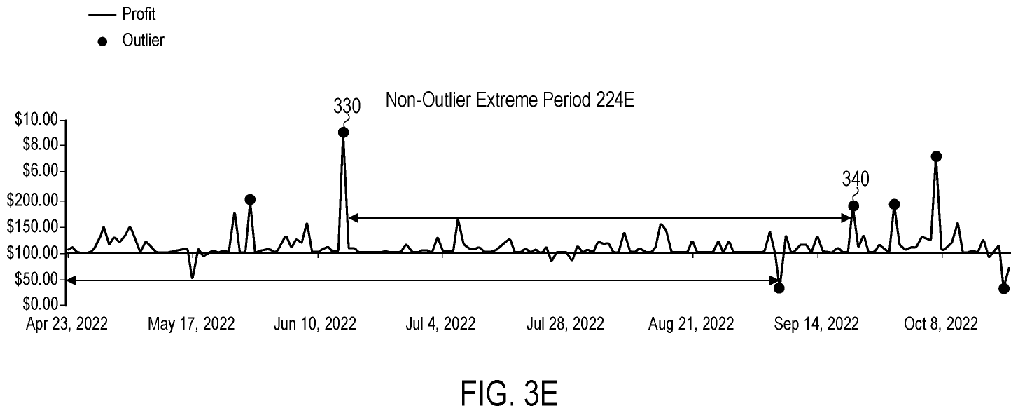

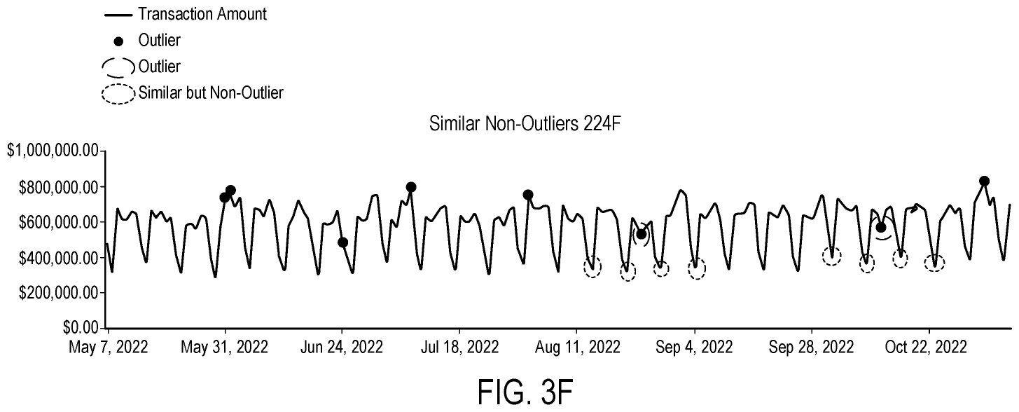

Time-series analysis engine 110, in various embodiments, is an automated system that identifies a final set of outlier data points 145 from a set of time-series data 115. Time-series analysis engine 110, in various embodiments, receives candidate outlier detection models 120, time-series data 115, and metadata 125. Candidate outlier detection models 120 are machine learning models used to predict and identify outlier data points that deviate significantly from the majority of data points. Candidate outlier detection models 120 are described in greater detail with respect to FIG. 2A. Time-series analysis engine 110, in various embodiments, provides candidate outlier detection models 120 and time-series data 115 to a model selection engine 130. Model selection engine 130, in various embodiments, applies the set of candidate outlier detection models 120 to time-series data 115 in which each candidate outlier detection model 120 generates a set of predicted outliers. Model selection engine 130, in various embodiments, scores each candidate outlier detection model's 120 predicted outliers, using a set of metrics, and selects one of the models 120 and its respective predicted outliers based on the model score. The set of metrics is discussed in greater detail with respect to FIG. 2B and FIG. 3A-F. Model selection engine 130 is discussed in greater detail with respect to FIG. 2A-C. Model selection engine 130, in various embodiments, provides a preliminary set of outlier data points 135 to time-series evaluation engine 140.

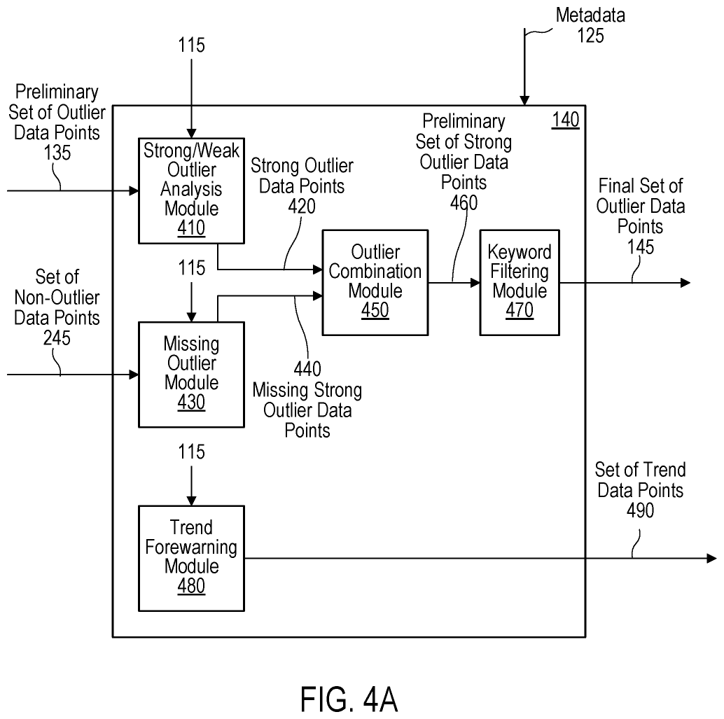

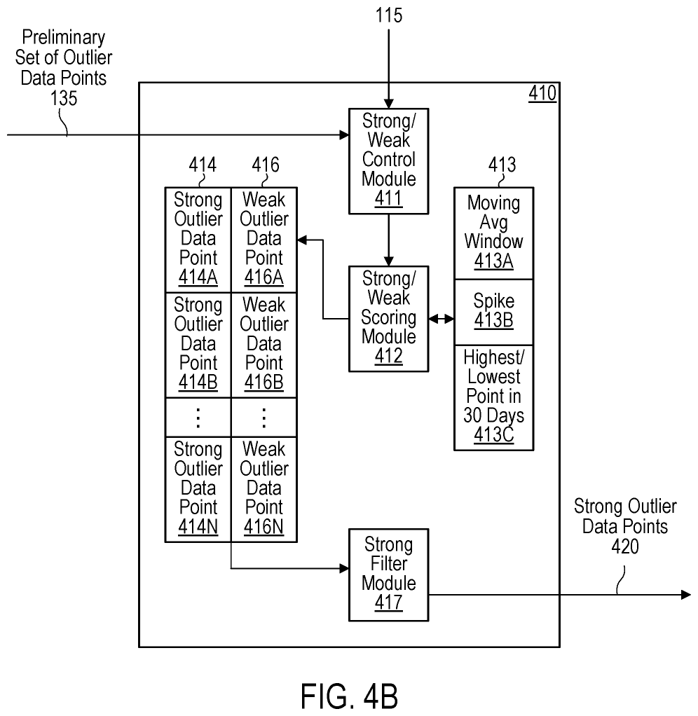

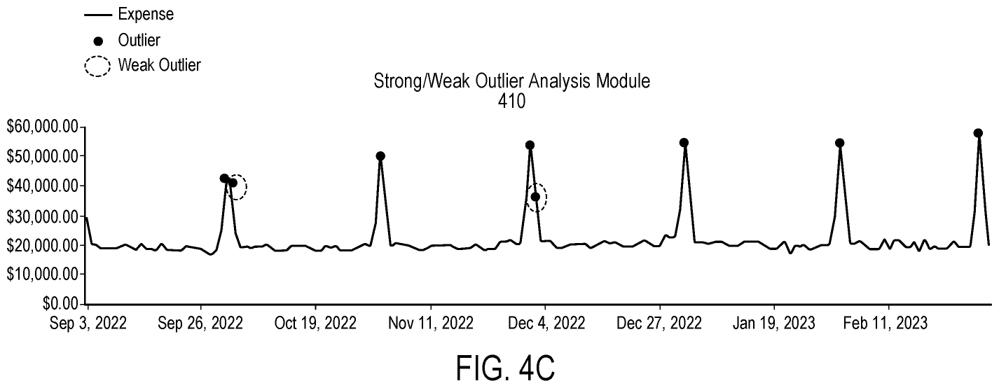

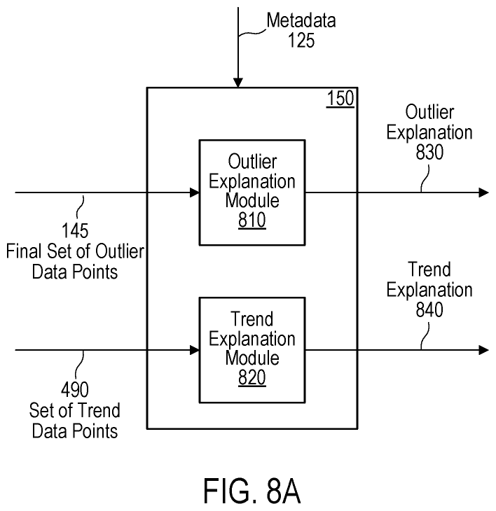

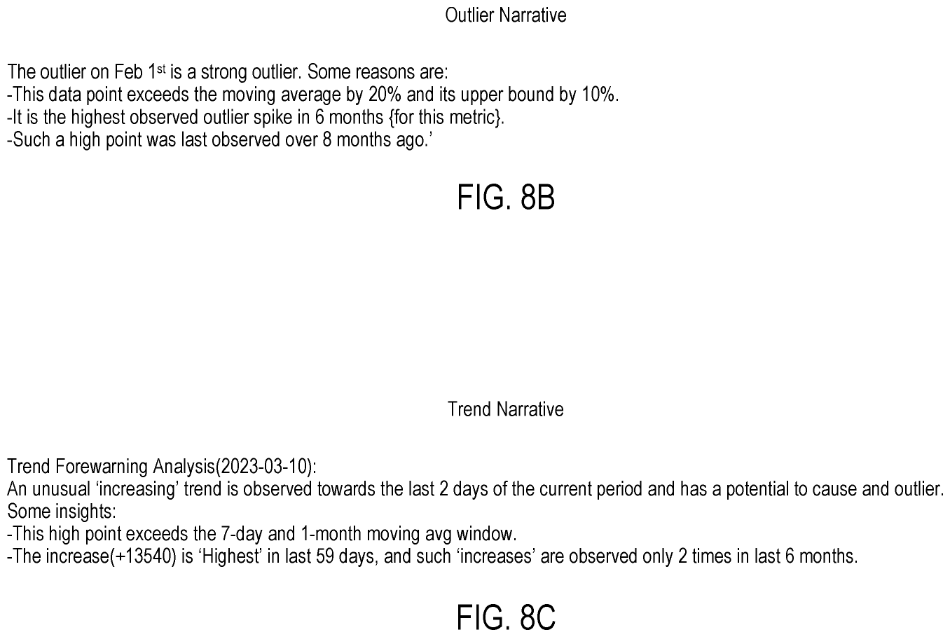

Time-series evaluation engine 140, in various embodiments, evaluates and filters outliers from the preliminary set of outlier data points 135 to generate a final set of outlier data points 145. Time-series evaluation engine 140, in various embodiments, may identify missing outliers from time-series data 115 that the selected candidate outlier detection model 120 failed to detect. Time-series evaluation engine 140 is discussed in further detail with respect to FIGS. 4-7. Finally, time-series evaluation engine 140, in various embodiments, provides the final set of outlier data points 145 to message engine 150. Message engine 150, in various embodiments, generates a narrative explaining the nature of the final set of outlier data points 145 to a user. Message engine 150 is discussed in further detail with respect to FIG. 8.

These techniques may be advantageous over prior approaches as these techniques allow for the automated identification of outliers in time-series data, including unlabeled data. Time-series evaluation engine 140 eliminates the need for manual labeling prior to analyzing the time-series data 115. Furthermore, time-series evaluation engine 140 evaluates a set of candidate outlier detection models 120 and selects the candidate model best suited for the type of time-series data 115. Thus, time-series evaluation engine 140 eliminates the need for manual parameter adjustments when dealing with different types of datasets. This is particularly useful when there are many different types of time-series data at issue. Time-series evaluation engine 140, in various embodiments, can also generate easy to understand and automated narratives for explaining the outliers to users. Thus, the narratives allow a user to make informed decisions, regarding the time-series data. Time-series evaluation engine 140 incorporates user domain knowledge during the filtering process to ensure the user is only notified about relevant outliers for the type of data identified. Finally, time-series evaluation engine 140 can identify missing outliers that may be missed by the selected candidate model.

These techniques can be used for a variety of purposes. For example, they may be used in a business risk management setting to track key risk indicators (KRIs) for computer transactions such as transaction per volume by identifying and analyzing data points that deviate significantly from a majority of other data points in that dataset. For example, tracking spikes in loss trends associated with cryptocurrency may help a user adjust related investment strategies. Using these techniques to track KRIs may also be used to mitigate risk related to high-risk countries. For example, an unexpected spike associated with a high transaction volume may indicate fraudulent behavior. By continuously monitoring KRIs, users can manage risk associated with their organization.

In one embodiment, the disclosed techniques could be used to implement a machine learning service that determines risk for a given user. For example, consider a merchant or business that wishes to start utilizing customer transaction or sales data. That user could provide its transaction data to system 100 in order to gain an interpretation of time-series data that includes outlier detection, as well as explanatory narratives in some implementations.

Turning now to FIG. 2A, a block diagram of an example model selection engine 130 that is performed by time-series analysis engine 110 is shown. In the illustrated embodiment, model selection engine 130 includes a control module 210, a model scoring module 220, a model selection module 240, and results 230. In some embodiments, model selection engine 130 is implemented differently than shown. As an example, results 230 may be stored in a location independent of model selection engine 130.

Model selection engine 130, in various embodiments, is software that is executable to select one of the candidate outlier detection models 120 and its respective preliminary set of outlier data points 135 and set of non-outlier data points 245 based on a scoring function, using model scoring module 220. The model selection engine 130, in various embodiments, receives time-series data 115 and candidate outlier detection models 120. Candidate outlier detection models 120 are machine learning models used to predict and identify data points that deviate significantly from the majority (e.g., outliers). Candidate outlier detection models 120, in various embodiments, may include, without limitation, probabilistic-based models, proximity-based models, density-based models, and/or linear models. Candidate outlier detection models 120, in various embodiments, may include the same model with different sets of performance parameters.

Probabilistic-based models, such as Gaussian Mixture Model (GMM), predict outliers based on the likelihood (e.g., probability) of a data point being an outlier. For example, given two distributions (e.g., normal and outlier), data points with higher probability of belonging to outlier distributions are considered anomalies. Probabilistic-based models can recognize complex patterns in different types of datasets but heavily rely on assumptions about the data distribution (e.g., Gaussian distribution). Probabilistic-based models can be computationally expensive and struggle to identify outliers in high-dimensional data.

Proximity-based models, such as K-Nearest Neighbor (KNN), identify outliers by determining dissimilarities between individual data points based on their distance (e.g., proximity), respectively, to the nearest data point in the dataset. For example, KNN calculates the distance from each data point to their respective neighboring data point and identifies an outlier if the data point is significantly farther away relative to the average measured distance. Proximity-based models are simple and intuitive and can capture outliers that deviate from the local data structure. However, proximity-based models struggle to identify outliers in high-dimensional data as the distance of data points increase drastically with higher dimensions.

Density-based models, such as K-Means Clustering, identify outliers by grouping data points into clusters based on their similarities and determining if a data point is located outside the cluster. For example, K-Means can be used to determine the center (e.g., mean location) of a dense cluster of data points, and then identify a data point significantly further away from the center of any dense cluster as an outlier. Density-based models can identify outliers in clusters that are irregular shapes and in high- and low-density regions. But density-based models struggle to identify outliers in high-dimensional data and may require fine tuning with multiple manual parameter adjustments.

Linear models, such as Prophet, identify outliers by fitting a linear line or linear relationship to the data points and identifying data points that deviate significantly from the line. For example, Prophet may use linear regression to predict future data points and identify outliers that deviate from the estimated linear line. Linear models are simple to interpret and computationally efficient when analyzing large-scale datasets. But because linear models assume a linear relationship between data points, linear models may fail to identify complex relationships between data points.

Control module 210, in various embodiments, is executable to manage candidate outlier detection models 120 and time-series data 115. In one embodiment, control module 210 independently applies each candidate outlier detection model 120 to the time-series data 115 to generate a set of predicted outliers 215 and non-outliers respective to each candidate outlier detection model 120. For example, one of the candidate outlier detection models 120 may be applied to time-series data 115 with fifteen data points and predict five outliers while a different one of candidate outlier detection models 120 may be applied and predict eight outliers. Model scoring module 220, in various embodiments, scores each candidate outlier detection model 120 independently based on their respective set of predicted outliers 215, using a scoring function and set of metrics. Model scoring module 220 is discussed in further detail with regards to FIG. 2B.

After generating a model score, model scoring module 220, in various embodiments, stores results 230 in a storage location (e.g., local memory, database, repository, etc.) accessible to a model selection module 240. Results 230, in various embodiments, include a model score 232, a set of predicted outliers 234, and a set of non-outliers associated with their respective one of candidate outlier detection models 120. Results 230 are discussed in further detail with respect to FIG. 2C. Model selection module 240, in various embodiments, selects one of the candidate outlier detection models 120 with the highest score and respective preliminary set of outlier data points 135 and set of non-outlier data points 245. Model selection module 240, in various embodiments, may select an ensemble of candidate outlier detection models 120. For example, model selection module 240 may combine results 230 of multiple candidate outlier detection models 120 to improve the performance of the models for predicting outliers.

Turning now to FIG. 2B, a block diagram of a model scoring module 220 is shown. In the illustrated embodiment, model scoring module 220 includes a scoring function module 222 and a set of metrics 224 for scoring each candidate outlier detection model 120. Model scoring module 220, in various embodiments, receives predicted outliers 215 from control module 210 and time-series data 115. In some embodiments, model scoring module 220 is implemented differently than shown. As an example, the set of metrics 224 may include additional metrics.

Model scoring module 220, in various embodiments, scores candidate outlier detection models 120, using a scoring function, by applying a set of metrics 224 to their respective predicted outliers 215 and aggregating the results. For example, a model score 232 is generated for each candidate outlier detection model 120 by aggregating the scores produced from applying the set of metrics 224 to its respective predicted outliers 215 and time-series data 115. The set of metrics 224, in various embodiments, includes a moving average window 224A, a spike rate 224B, outlier distances 224C, an outlier extreme period 224D, a non-outlier extreme period 224E, and a similar non-outlier 224F.

Metric moving average window 224A, in various embodiments, calculates the moving average value of consecutive data points with a moving upper and lower boundary (e.g., window) to identify outliers. Moving average window 224A is applied to time-series data 115 to calculate the moving average value based on a set time period (e.g., monthly, daily, etc.). For example, the moving average value may be calculated based on consecutive data points from the past 30 days. The moving boundary, in various embodiments, is calculated based on the standard deviation from the moving average and a set coefficient. For example, the standard deviation from the moving average may be a value of 10 and the coefficient is 1.2, generating a moving boundary of 12. Moving average window 224A, in various embodiments, may be an average of multiple types of moving average windows based on different time periods. For example, a moving average window based on the past 30 days and a moving average based on the past 7 days may be combined to generate a final moving average window 224A. After the moving average window 224A is determined, model scoring module 220 applies the moving average window 224A to the predicted outliers 215 and scores the outliers based on their position. The aggregated value calculated from moving average window 224A is used to generate a final model score 232 for each candidate outlier detection model 120. An example of moving average window 224A is shown with regards to FIG. 3A.

Metric spike rate 224B, in various embodiments, calculates the rate of outliers with spikes from the total number of predicted outliers 215. A spike is a sharp peak observed in the time-series data 115. For example, if a data point is located between an abrupt increase followed by an abrupt decrease, the data point is considered a spike. Similarly, a data point is considered a spike when located between an abrupt decrease followed an abrupt increase. Model scoring module 220 applies spike rate 224B to predicted outliers 215 and generates a score based on the number of observed spikes. For example, one of the candidate outlier detection models 120 may predict five outliers in which only four of the outliers are spikes, and thus, spike rate 224B is 0.8. The value calculated by spike rate 224B is used to generate the final model score 232 for each candidate outlier detection model 120. An example of spike rate 224B is shown with regards to FIG. 3B.

Metric outlier distances 224C, in various embodiments, calculates a value for the average distance of a model's predictive outliers 215 from the moving average. For example, predictive outliers 215 may include five outliers with a distance of 10 units, 25 units, 5 units, 40 units and 15 units respectively, and thus the average distance is calculated as 19 units. Metric outlier distances 224C, in various embodiments, may include combinations of distances from different moving average values based on different time periods as discussed with moving average window 224A. The value calculated from outlier distances 224C is used to generate a final model score 232 for each candidate outlier detection model 120. An example of outlier distances 224C is shown with regards to FIG. 3C.

Metric outlier extreme period 224D relates to the length of time between outliers identified by selected model 120. A given identified outlier will have some length of time that it is a local minimum or maximum relative to other data points in time series data 115. This time period can be referred to as the outlier's “extreme period,” since it measures the amount of time the outlier is an extreme value (i.e., a local minimum/maximum).

Metric outlier extreme period 224D is computed using the length of the extreme period for each outlier. In one embodiment, the computation of metric 224D takes into account whether the outlier is a spike. If a particular outlier is classified as a spike, an extreme period is computed on each side of the outlier data point (that is, an extreme period is computed in which the outlier in question is the end of an extreme period, and another extreme period is computed in which the outlier is the beginning of an extreme period). In contrast, if an outlier is not classified as a spike and thus is located next to a neighboring spike outlier, metric 224D does not consider the extreme period between the non-spike outlier and the neighboring spike outlier. This distinction is illustrated below with respect to FIG. 3D. Once obtained, the various lengths of the pertinent extreme periods are averaged to determine metric 224D. In general, a higher value of metric 224D indicates better detection performance.

Metric non-outlier extreme period 224E, in various embodiments, relates to the length of time between prominent non-outliers (e.g., non-outliers located farthest from the moving average line) within a set of outliers identified by selected model 120. This time period can be referred to as the non-outlier's “extreme period,” since it measures the amount of time the non-outlier is an extreme value (i.e., a local minimum/maximum). Metric non-outlier extreme period 224E is computed using the length of the extreme period for the ten most prominent non-outliers. Once obtained, the various lengths of the pertinent non-outlier extreme periods are averaged to determine metric 224E. In general, a lower value of metric 224E indicates better detection performance. An example of non-outlier extreme period 224E is shown with regards to FIG. 3E.

Similar non-outlier 224F, in various embodiments, identify non-outliers that exhibit similar characteristics to the predicted outliers 215 within a set period of time (e.g., 30 days). For example, a non-outlier data point exhibiting a spike similar to or more prominent than a predicted outlier 215 within a 30-day time period may not be detected, and thus, the respective candidate outlier detection model 120 may score poorly. The value calculated from similar non-outlier 224F is used to generate a final model score 232 for each candidate outlier detection model 120. An example of similar non-outlier 224F is shown with regards to FIG. 3F.

Model scoring module 220, in various embodiments, applies the set of metrics 224 to the predicted outliers 215 and generates a score associated with the metric, using a scoring function. Each metric 224 score, in various embodiments, may be weighted differently based on their level of importance by applying a coefficient to each metric score in order to generate a final model score 232. For example, moving average window 224A may be considered more significant for certain type of time-series data 115 and thus is given a coefficient greater than 1. After a score is generated for each metric 224 respectively, model scoring module 220 aggregates the scores into a final model score 232. For example, candidate model A receives a model A score 236A based on its respective predicted outliers 215 and metric scores, and candidate model B receives a model B score 232B based on its respective predicted outliers 215 and metric scores. Model scores 232 are stored in a storage location (e.g., local memory, database, repository, etc.) accessible to a model selection module 240.

Turning now to FIG. 2C, a block diagram of a model selection module 240 is shown. In the illustrated embodiment, model selection module 240 selects a model score 232 from results 230. As further illustrated, results 230 include a model's predicted outliers 234 and a model's non-outliers 236. In some embodiments, model selection module 240 is implemented differently than shown. As an example, results 230 may include storing additional metadata regarding candidate outlier detection models 120.

Model selection module 240, in various embodiments, selects one of the candidate outlier detection models 120 and its respective predicted outliers 234 and non-outliers 236 based on score 232. In various embodiments, a “better” score 232 equates to better outlier detection performance, where “better” is assessed relative to a set of criteria. For example, a higher score equates to better outlier detection performance. Model selection module 240 selects one of the candidate outlier detection models 120 from a set of candidate outlier detection models 120 based on score 232 with the highest value. For example, candidate outlier detection model B 120 may score higher than candidate outlier detection model A 120 for time-series data 115 and thus model B is selected. In various embodiments, the selection may consist of an ensemble of models. For example, model selection module 240 may select a combination of candidate outlier detection models 120 (e.g., model A and model B). The selected model's predicted outliers 234B and non-outliers 236B become the preliminary set of outlier data points 135 and set of non-outlier data points 245.

Turning now to FIG. 3A, a chart diagram for an example of moving average window 224A is shown. In the illustration, time-series data 115 includes data points recorded in a six-month time period, and the moving average (e.g., bold dashed line) is calculated by averaging all data points in the six-month period. In the illustration, the moving average boundary (e.g., dashed lines) is calculated by averaging the deviation of all data points from the moving average line. When metric moving average window 224A is applied to predicted outliers 215, scoring function module 222 scores each candidate outlier detection model 120 based on the location of their respective predicted outliers 215 relative to the moving average boundary. In this example, one of the candidate outlier detection models 120 has predicted ten outliers in the six-month period. Five predicted outliers 215 are located outside the moving average boundary and are classified as distant outliers (denoted by long-dash ellipses). The remaining five predicted outliers 215 are located inside the moving average boundary and are classified as non-distant outliers (denoted by short-dash ellipses). Since five of the ten predicted outliers 215 are classified as distant outliers, scoring function module 222 calculates a score of 0.5 for the respective candidate outlier detection model 120. In various embodiments, candidate outlier detection models 120 with higher scores for moving average window 224A equates to better outlier detection performance for time-series data 115.

Turning now to FIG. 3B, a chart diagram for an example of spike rate 224B is shown. In the illustration, time-series data 115 includes data points recorded in a six-month time period, and one of the candidate outlier detection models 120 has predicted six outliers. As previously discussed, a spike is a data point located between an abrupt increase followed by an abrupt decrease or a data point located between an abrupt decrease followed by abrupt increase. In the illustration, five of the six predicted outliers 215 exhibit this characteristic and are classified as a spike (denoted by long-dash ellipses). The remaining predicted outlier 215 is a data point located between a decrease followed by an additional decrease and is classified as a non-spike outlier (denoted by short-dash ellipses). Since five of the six predicted outliers 215 are classified as spikes, scoring function module 222 calculates a score of 0.83 for the respective candidate outlier detection model 120 in the depicted example. In various embodiments, candidate outlier detection models 120 with higher scores for spike rate 224B equates to better outlier detection performance for time-series data 115.

Turning now to FIG. 3C, a chart diagram for an example of outlier distances 224C is shown. In the illustration, time-series data 115 includes data points recorded in a six-month time period, and one of the candidate outlier detection models 120 has predicted six outliers. As previously discussed, the outlier distance is the distance from the moving average line to the predicted outlier 215. The distance between the average line is determined for each distant outlier (denoted by long-dash ellipses) and non-distant outlier (denoted by short-dash ellipses) data point. In the example, the distances for the non-distant outliers are 3, 8, 5, and 6 respectively, and the distance for the distant outliers are 20 and 18 respectively. Scoring function module 222 calculates the average distance of the predicted outliers 215 and generates a score of 10 for the respective candidate outlier detection model 120. In various embodiments, candidate outlier detection models 120 with higher scores for outlier distances 224C equates to better outlier detection performance for time-series data 115.

Turning now to FIG. 3D, a chart diagram for an example of outlier extreme period 224D is shown. In the illustration, time-series data 115 includes data points recorded in a six-month time period. One of the candidate outlier detection models 120 has predicted eight outliers, including seven spike outliers and one non-spike outlier. In the illustration, the non-spike outlier 310 is located next to a neighboring spike, and thus metric 224D does not consider the short extreme period between the non-spike outlier and the neighboring outlier in the scoring process. In contrast, metric 224D computes the extreme period located on the left and right side of the spike outlier 320 as shown. Metric 224D is computed by averaging the length between all predicted outliers and uses this average computed length to score one of models 120. In various embodiments, candidate outlier detection models 120 with higher scores for extreme outlier periods 224D will be regarded as having better outlier detection performance for time-series data 115.

Turning now to FIG. 3E, a chart diagram for an example of non-outlier extreme period 224E is shown. In the illustration, time-series data 115 includes data points recorded in a six-month time period, and one of the candidate outlier detection models 120 has predicted seven outliers. As previously discussed, a non-outlier extreme period is a period of time between prominent non-outliers located within a set of predicted outliers (e.g., outlier 330 and outlier 340). Metric 224E identifies ten of the most prominent non-outliers, based on their distance from the moving average line, and computes the average length of the non-outlier extreme period between each prominent non-outlier data point. Scoring function module 222 calculates a score for the respective candidate outlier detection model 120 based on the average length of the non-outlier extreme period. In various embodiments, candidate outlier detection models 120 with lower scores for outlier extreme period 224D equates to better outlier detection performance for time-series data 115.

Turning now to FIG. 3F, a chart diagram for an example of similar non-outlier 224F is shown. In the illustration, time-series data 115 includes data points recorded in a six-month time period, and one of the candidate outlier detection models 120 has predicted eight outliers. As previously discussed, an outlier and non-outlier are classified as similar when the non-outlier exhibits a similar spike as the outlier within a set period of time (e.g., 30 days). In the illustration, scoring function module 220 has identified two sets of four similar non-outliers (short-dash ellipses) neighboring one predicted outlier 215 (long-dash ellipses) with more prominent spikes. Scoring function module 222 calculates a score for the respective candidate outlier detection model 120 based on the characteristics of the non-outlier data points. In various embodiments, candidate outlier detection models 120 with lower scores for similar non-outlier 224F equates to better outlier detection performance for time-series data 115.

Turning now to FIG. 4, a block diagram of time-series evaluation engine 140 is shown. In the illustrated embodiment, time-series evaluation engine 140 includes a strong/weak outlier analysis module 410, a missing outlier module 430, an outlier combination module 450, a keyword filtering module 470, and a trend forewarning module 480. In some embodiments, time-series evaluation engine 140 is implemented differently than shown. As an example, trend forewarning module 480 may be deployed independently from time-series evaluation engine 140.

Time-series evaluation engine 140, in various embodiments, is software that is executable to filter outliers from a preliminary set of outlier data points 135, using strong/weak outlier analysis module 410 and keyword filtering module 470, to generate a final set of outlier data points 145. Strong/weak outlier analysis module 410, in various embodiments, receives time-series data 115 and the preliminary set of outlier data points 135 from model selection engine 130. Strong/weak outlier analysis module 410 classifies and filters outliers based on a set of metrics to generate strong outlier data points 420. Strong/weak outlier analysis module 410 is discussed in greater detail with respect to FIGS. 4B and 4C. The strong outlier data points 420, in various embodiments, may be combined with a set of missing outliers identified, using missing outlier module 430.

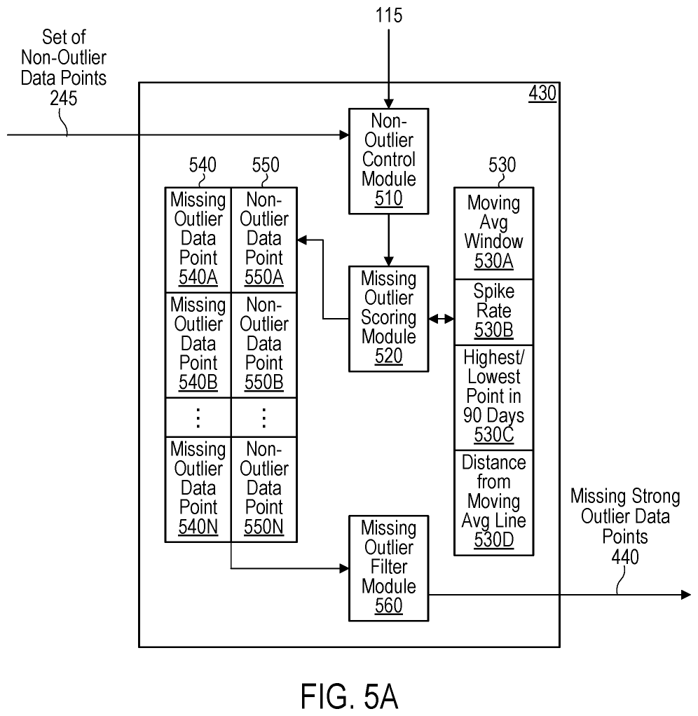

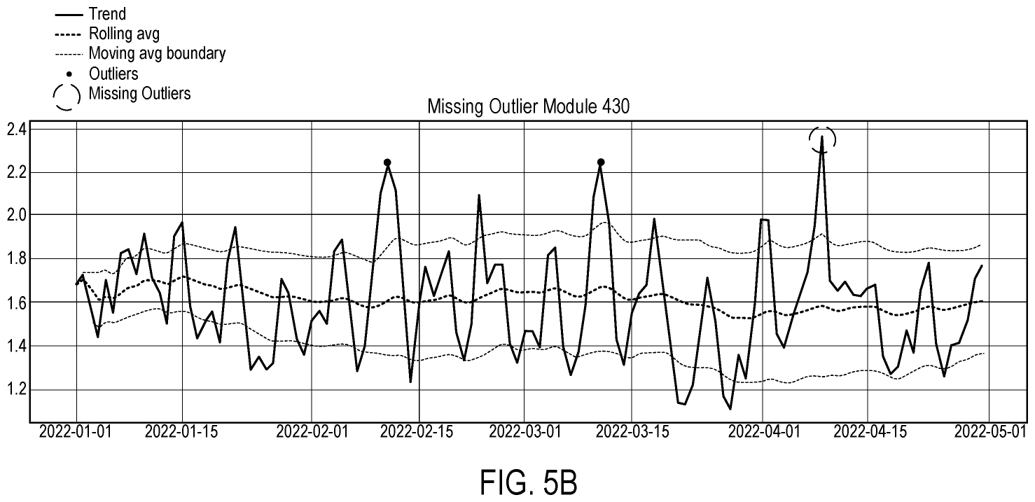

Missing outlier module 430, in various embodiments, is software that is executable to identify potential missing outliers from the set of non-outlier data points 245, based on a set of metrics, to generate missing strong outlier data points 440. Missing outlier module 430 is discussed in greater detail with respect to FIGS. 5A and 5B. Outlier combination module 450, in various embodiments, combines strong outlier data points 420 and missing strong outlier data points 440 into a preliminary set of strong outlier data points 460. For example, strong outlier data points 420 may include 4 strong outlier data points and missing strong outlier data points 440 may include 1 strong outlier data point. Outlier combination module 450 combines the five strong outlier data points into a single set (e.g., preliminary set of strong outlier data points 460).

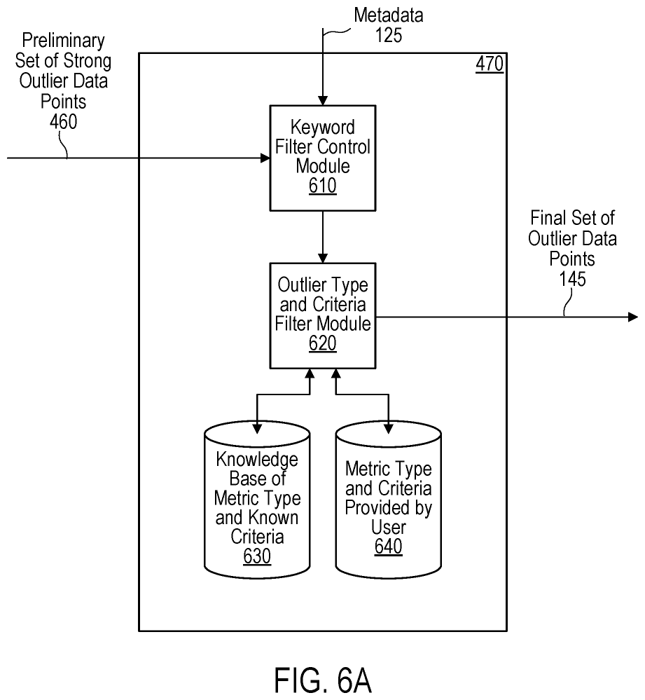

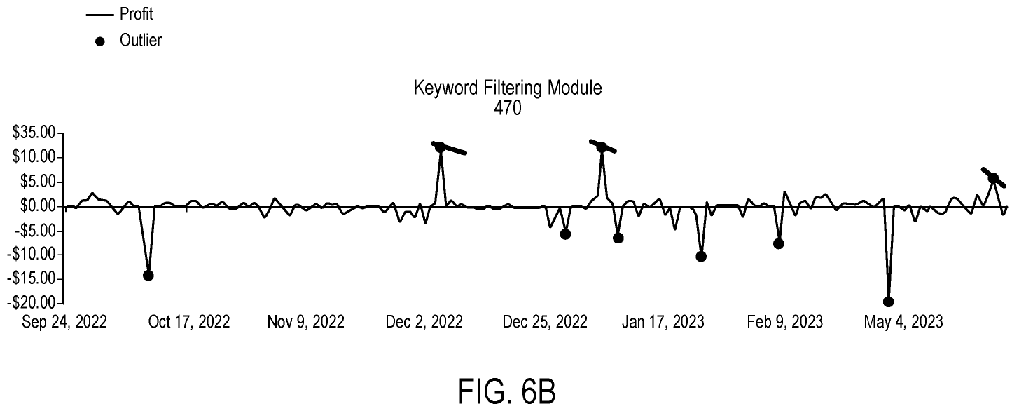

Keyword filtering module 470, in various embodiments, is software that is executable to filter outliers from the preliminary set of strong outlier data points 460, using keywords and user domain knowledge, to produce a final set of outlier data points 145. The final set of outlier data points 145 is provided to message engine 150 in which the final set of outlier data points 145 may be used to generate a narrative about the outlier data points observed in time-series data 115. Keyword filtering module 470 is discussed in greater detail with respect to FIGS. 6A and 6B.

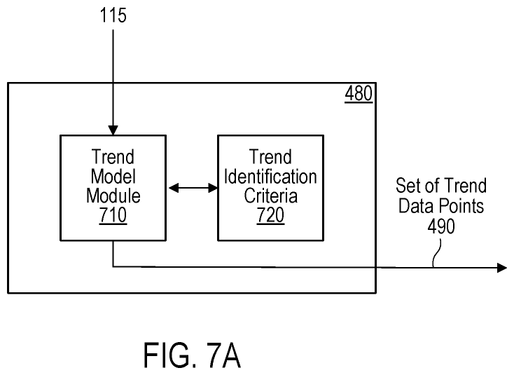

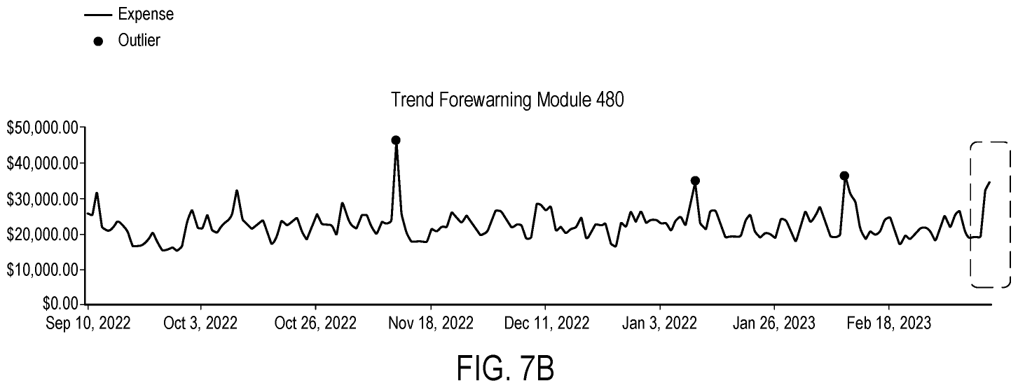

Trend forewarning module 480, in various embodiments, is software that is executable to identify a set of trend data points 490 for time-series data 115. As discussed, a trend is a consecutive set of data points that are monotonically increasing or decreasing over a set time period. The set of trend data points 490 is provided to message engine 150 in which the set of trend data points 490 may be used to generate a narrative about the trend data points observed in time-series data 115. Trend forewarning module 480 is discussed in further detail with respect to FIGS. 7A-B.

Turning now to FIG. 4B, a block diagram of strong/weak outlier analysis module 410 is shown. In the illustrated embodiment, strong/weak outlier analysis module 410 includes a strong/weak control module 411, a strong/weak scoring module 412, a set of metrics 413, and a strong filter module 417. In some embodiments, strong/weak control module 411 is implemented differently than shown. As an example, strong outlier data point 414 and weak outlier data point 416 may be stored in a location independent of strong/weak outlier analysis module 410.

Preliminary set of outlier data points 135, in various embodiments, includes, as the name suggests, data points that have been classified as outliers by a selected one of models 120. The inventors recognize, however, that there is a spectrum of outlier data points, and there are reasons to have more confidence in some putative outlier data points as opposed to others. Accordingly, the present disclosure refers to a determination of “strong” and “weak” outliers. As used herein, “strong” and “weak” outliers are different sub-classes of data points that have been classified as outliers. A strong outlier is a data point that satisfies some heightened set of criteria that other (weak) outliers do not.

Strong/weak outlier analysis module 410, in various embodiments, classifies an outlier as strong or weak, using a strong/weak scoring module 412 and a set of metrics 413, and filters the weak outlier data points, using strong filter module 417, to generate a set of strong outlier data points 420. Strong/weak outlier analysis module 410 receives time-series data 115 and preliminary set of outlier data points 135 from model selection engine 130 via strong/weak control module 411. Strong/weak control module 411, in various embodiments, coordinates the interaction between strong/weak scoring module 412, preliminary set of outlier data points 135, and time-series data 115. For example, strong/weak control module 411 may provide a single outlier data point from a set of outlier data points to strong/weak scoring module 412. Strong/weak scoring module 412, in various embodiments, applies a set of metrics 413 to an outlier data point to classify the outlier data point as a strong outlier data point 414 or a weak outlier data point 416 based on its respective score. For example, an outlier data point with a score below a certain threshold may be classified as a weak outlier data point 416, and an outlier data point above a certain threshold may be classified as a strong outlier data point 414. The set of metrics 413, in various embodiments, includes moving average window 413A, spike 413B, and highest/lowest point in 30 days 413C. Moving average window 413A is similar to moving average window 224A as previously discussed in respect to FIG. 2B, but metrics 413, in various embodiments, are applied and scored based on a singular outlier data point instead of an aggregated set of outlier data points. In various embodiments, the outlier data point is classified as a strong outlier data point 414 if it satisfies all metrics 413. In other embodiments, the distinction between a strong and weak outlier may be based on a scoring threshold.

Strong/weak scoring module 412, in various embodiments, applies metric moving average window 413A to an outlier data point and determines if the outlier is located outside the moving average boundary. For example, the outlier is classified as a weak outlier data point 416 if the outlier is located inside the moving average boundary. If the outlier is located outside the moving average boundary, the outlier may be classified as a strong outlier data point 414. Strong/weak scoring module 412, in various embodiments, applies metric spike 413B to an outlier data point and determines if the outlier is a spike. For example, the outlier is classified as a weak outlier data point 416 if the outlier is not a spike. If the outlier is determined to be a spike, the outlier may be classified as a strong outlier data point 414. Strong/weak scoring module 412, in various embodiments, applies metric highest/lowest point in 30 days 413C to an outlier data point and determines if the outlier is the highest or lowest data point in the past 30 days. For example, the outlier is classified as a weak outlier data point 416 if another more prominent outlier is observed within the same 30-day time period. Metric 413C, in various embodiments, may be adjusted to determine if an outlier is the highest or lowest data point in different set time period. After the preliminary set of outlier data points 135 are individually classified as strong or weak, the strong outlier data points 414 and weak outlier data points 416 are stored in a location accessible by strong filter module 417.

Note that additional metrics or an alternative set of metrics 413 may be employed in other embodiments to differentiate strong vs. weak outliers.

Strong filter module 417, in various embodiments, filters the weak outlier data points 416 from the preliminary set of outlier data points 135 to generate a set of strong outlier data points 420. For example, preliminary set of outlier data points 135 may include five outliers with three strong outlier data points 414 and two weak outlier data points 416, and strong filter module 417 filters the two weak data points to generate the set of strong outlier data points 420. One possible implementation of strong/weak outlier analysis module 410 is shown with respect to FIG. 4C. The set of strong outlier data points 420 is provided to outlier combination module 450, in which the set of strong outlier data points 420 may be combined with missing strong outlier data points 440.

Turning now to FIG. 4C, an example of strong/weak outlier analysis module 410 is shown. In the illustration, time-series data 115 includes data points recorded in a six-month time period, and selected candidate outlier detection model 120 has predicted eight outliers. Of these identified outliers, strong/weak scoring module 412 has identified two weak outlier data points, which are indicated inside dashed ellipses. As shown, the two outlier data points are located next to data points that are higher and lower than the outlier, and thus, the two outlier data points are identified as weak based on metric highest/lowest point in 30 days 413C. Similarly, the two outlier data points do not exhibit a characteristic of a spike and are identified as weak based on spike 413B. The two weak outlier data points 416 are filtered from the remaining outlier data points to generate the set of strong outlier data points 420.

Turning now to FIG. 5A, a block diagram of one embodiment of a missing outlier module 430 is shown. In the illustrated embodiment, missing outlier module 430 includes a non-outlier control module 510, a missing outlier scoring module 520, a set of metrics 530, and a missing outlier filter module 560. In some embodiments, missing outlier module 430 is implemented differently than shown. As an example, missing outlier data point 540 and non-outlier data point 550 may be stored in a location independent of missing outlier module 430.

Missing outlier module 430, in various embodiments, identifies missing outliers from a set of non-outlier data points 245, using missing outlier scoring module 520 and set of metrics 530. Missing outlier module 430 receives time-series data 115 and a set of non-outlier data points 245 from model selection engine 130 via non-outlier control module 510. Non-outlier control module 510, in various embodiments, coordinates the interaction between missing outlier scoring module 520, set of non-outlier data points 245, and time-series data 115. For example, non-outlier control module 510 may provide, in succession, single non-outlier data points from set of non-outlier data points 245 to missing outlier scoring module 520. Missing outlier scoring module 520, in various embodiments, then applies set of metrics 530 to a non-outlier data point to determine if the non-outlier data point is a missing outlier based on its respective score. For example, a non-outlier data point with a score above a certain threshold may be classified as a missing outlier data point 540. Set of metrics 530, in the depicted embodiment, includes moving average window 530A, spike rate 530B, highest/lowest point in 90 days 530C, and distance from moving average line 530D. (Alternate metrics may be used in other implementations of module 430). Moving average window 530A, spike rate 530B, and distance from moving average line 530D are similar to moving average window 224A, spike rate 224B, and outlier distances 224C previously discussed with respect to FIG. 2B, but metrics 530, in various embodiments, are applied and scored based on a singular non-outlier data point instead of an aggregated set of outlier data points. In one embodiment, the non-outlier data point is classified as a missing outlier data point 540 if it satisfies all metrics 530, but other criteria for assessing a data point as a missing outlier are also possible.

Missing outlier scoring module 520, in various embodiments, applies metric moving average window 530A to a non-outlier data point and determines if the non-outlier is located outside the moving average boundary. For example, this metric may indicate a missing outlier data point 540 if the data point is located outside the moving average boundary. Missing outlier scoring module 520, in various embodiments, applies metric spike rate 530B to a data point to determine if it is a spike. For example, this metric may indicate that a data point should be classified as a missing outlier data point 540 if the non-outlier data point exhibits a spike characteristic.

Missing outlier scoring module 520, in various embodiments, applies metric highest/lowest point in 90 days 530C to a non-outlier data point and determines if the non-outlier is the highest or lowest data point in the past 90 days for time-series data 115. For example, this metric may indicate a missing outlier data point 540 if the data point is the highest data point observed within the 90-day time period. Metric 530C, in various embodiments, may be adjusted to determine if an outlier is the highest or lowest data point within a different time period. Missing outlier scoring module 520, in various embodiments, applies distance from moving average line 530D to a non-outlier data point and determines if the non-outlier is located above or below a set distance threshold. For example, this metric may indicate a missing outlier data point 540 if the data point is located above the distance threshold. After the preliminary set of non-outlier data points 245 are individually classified as missing outliers or non-outliers, the missing outlier data points 540 and non-outlier data points 550 are stored in a location accessible by missing outlier filter module 560.

Missing outlier filter module 560, in various embodiments, filters the non-outlier data points 550 from the set of non-outlier data points 245 to generate a set of missing strong outlier data points 440. For example, the set of non-outlier data points 245 may originally include five non-outliers, but missing outlier scoring module 520 may identify one missing outlier from the set of non-outlier data points 245. In this example, missing outlier filter module 560 filters out the four remaining non-outlier data points to generate the set of missing strong outlier data points 440. A graphical depiction of the use of missing outlier module 430 is shown with respect to FIG. 5B. The set of missing strong outlier data points 440 is provided to outlier combination module 450 along with strong outlier data points 420.

Turning now to FIG. 5B, a chart illustrating an example of the application of missing outlier module 430 is shown. In the illustration, time-series data 115 includes data points recorded in a four-month time period, and selected candidate outlier detection model 120 has predicted two outliers. Out of the remaining non-outliers, missing outlier scoring module 520 has identified one missing outlier data point (indicated by a dashed ellipse) based on metrics 530. The missing outlier data point is determined as such by virtue of its being located outside the moving average boundary (e.g., dashed line), exhibiting the characteristics of a spike, is the highest data point within a 90-day period, and being above a set threshold distance from the moving average line (e.g., bold dashed line). Thus, the non-outlier data point is classified as a missing outlier data point 540 and is combined with the original two predicted outliers into a preliminary set of strong outlier data points 460.

Turning now to FIG. 6A, a block diagram of one embodiment of keyword filtering module 470 is shown. In the illustrated embodiment, keyword filtering module 470 includes a keyword filter control module 610 and an outlier type and criteria filter module 620. Keyword filtering module 470 further includes a storage repository storing data pertaining to knowledge base of metric type and known criteria 630 and a metric type and criteria provided by user 640. In some embodiments, keyword filtering module 470 is implemented differently than shown. As an example, outlier type and criteria filter module 620 may access a repository located outside of keyword filtering module 470.

Keyword filtering module 470, in various embodiments, filters outliers from a preliminary set of strong outlier data points 460 based on metadata 125 and heuristics associated with time-series data 115. Keyword filtering module 470 receives a preliminary set of strong outlier data points 460 from outlier combination module 450 and metadata 125 associated with time-series data 115 via keyword filtering control module 610. Keyword filtering control module 610, in various embodiments, coordinates the interaction between outlier type and criteria filter module 620, preliminary set of strong outlier data points 460, and metadata 125. For example, keyword filtering control module 610 may provide, in succession, single outlier data points from a set of outlier data points to outlier type and criteria filter module 620.

Outlier type and criteria filter module 620, in various embodiments, filters outliers based on known heuristics and/or user input by accessing a storage storing data pertaining to a knowledge base of metric type and known criteria 630 and metric type and criteria provided by user 640. Knowledge base 630, in various embodiments, stores known heuristics pertaining to the metric type of time-series data 115. The metric type, in various embodiments, may be related, but not limited to, keywords in the metric such as “profit,” “loss,” “revenue,” and “total payment volume (TPV).” Outlier type and criteria filter module 620 can use information from knowledge base 630 to filter outliers based on the metric type and thus eliminate certain types of outliers, thus allowing a user to focus on a smaller set of outliers. For example, when time-series data 115 is related to revenue, outlier type and criteria filter module 620 may filter outliers corresponding to an upward spike from the preliminary set of strong outlier data points 460 based on the metric type including the word “revenue,” for example. As another example, the metric type for time-series data 115 may contain the keyword “loss,” causing outlier type and criteria filter module 620 to filter out strong outlier data points associated with a downward spike (since these may be expected).

Metric type and criteria provided by user 640, in various embodiments, is data pertaining to the metric type of time-series data 115 provided by a user. Thus, while knowledge base 630 may store generally applicable domain-specific knowledge, criteria 640 may be specific to a particular user. Outlier type and criteria filter module 620, in various embodiments, is customizable, based on a user's input, to filter outliers to satisfy the user's particular needs or preferences. For example, a user may include an upper or lower threshold for time-series data 115, and if the outlier does not exceed the threshold, the outlier is filtered from final set of outlier data points 145. A user may also be concerned only with upward spikes in time-series data 115 (as this may indicates a negative connotation regarding a user's desired goal), and thus outlier type and criteria filter module 620 can set to filter all outliers that do not exhibit an upward spike. An example of keyword filtering module 470 is shown with respect to FIG. 6B.

Turning now to FIG. 6B, a chart illustrating an example of the use of keyword filtering module 470 is shown. In the illustration, time-series data 115 includes data points recorded in a seven-month time period. Selected candidate outlier detection model 120 has predicted nine outlier data points. The nine outlier data points include three data points with an upward spike and six outlier data points with a downward spike. In this illustration, time-series data 115 includes data points with numerical values related to profit. With respect to profit outliers, a user may only be concerned with a downward spike in time-series data 115 as this indicates a negative connotation regarding a user's desired goal, and thus all outliers with an upward spike may be filtered from final set of outlier data points 145. As shown, outlier type and criteria filter module 620 filters the three outlier data points exhibiting an upward spike, and final set of outlier data points 145 includes only outliers exhibiting a downward spike.

Turning now to FIG. 7A, a trend forewarning module 480 is shown. In the illustrated embodiment, trend forewarning module 480 includes a trend model module 710 and trend identification criteria 720. In some embodiments, trend forewarning module 480 is implemented differently than shown. As an example, trend forewarning module 480 may use a scoring module to identify trends in time-series data 115.

Trend forewarning module 480, in various embodiments, is software that is executable to identify a trend with the probability of generating an outlier in time-series data 115, using trend model module 710. As discussed, a trend is a set of sequential data points that monotonically increase or decrease over a set period of time. Trend model module 710, in various embodiments, receives time-series data 115 and applies a set of trend identification criteria 720. Trend identification criteria 720, in various embodiments, includes determining if the increase/decrease value between sequential data points is the highest observed value in the last 30 days and has occurred less than three times in 6 months and if the newest data point is located outside the moving average window. For example, trend model module 710 may identify a trend if the sequential data points monotonically increase substantially over a 3-day time period, and the newest data point in the trend is recorded outside the moving average window. When a trend is identified, trend model module 710 generates a set of trend data points 490, and the trend data points are provided to message engine 150. Trend data points 490, in various embodiments, may be used to notify a user of a potential upcoming outlier in the trend. An example of trend forewarning module 480 is shown with respect to FIG. 7B.

Turning now to FIG. 7B, a chart illustrating an example of the use of trend forewarning module 480 is shown. In the illustration, time-series data 115 includes data points recorded in a six-month time period. Selected candidate outlier detection model 120 has predicted three outlier data points. In the illustration, the latest recorded data points are monotonically increasing, and the newest recorded data point is the highest data point observed in a 30-day period. Thus, trend forewarning module 480 has identified the set of data points as a trend (e.g., dashed line) with the potential to be identified as an outlier. In general, the more abnormal the latest trend is considered, the greater probability it has for generating an outlier.

Turning now to FIG. 8A, a block diagram of one embodiment of a message engine 150 is shown. In the illustrated embodiment, message engine 150 includes an outlier explanation module 810 and trend explanation module 820. Message engine 150 receives final set of outlier data points 145 and set of trend data points 490 and outputs outlier explanation 830 and trend explanation 840, respectively.

Message engine 150, in various embodiments, is software that is executable to generate an outlier explanation 830 and/or a trend explanation 840 to explain strong outliers and trends respectively to a user. Message engine 150 receives a final set of outlier data points 145 from time-series evaluation engine 140 and metadata 125 and provides the data to outlier explanation module 810. Outlier explanation module 810, in various embodiments, uses the final set of outlier data points 145 and metadata 125 to generate a narrative (e.g., outlier explanation 830) explaining the nature of the outlier to the users. Outlier explanation 830, in various embodiments, may include statistics about the outlier data point that are measured using metrics 224 and metadata 125. For example, an outlier may exceed the moving average by 10% and is the lowest data point observed in the past two months. An example of an outlier narrative is provided with respect to FIG. 8B. Similarly, message engine 150 receives a set of trend data points 490 from time-series evaluation engine 140 and metadata 125 and provides the data to trend explanation module 820. Trend explanation module 820, in various embodiments, uses the set of trend data points 490 and metadata 125 to generate a narrative (e.g., trend explanation 840) explaining the nature of the trend to the users. Trend explanation 840, in various embodiments, includes statistics, about the trending data points, measured using trend identification criteria 720 and metadata 125. For example, a trend may exceed the moving average line by 7% and includes the highest data point observed in the past month. An example of a trend narrative is provided with respect to FIG. 8C.

Turning now to FIG. 8B, a diagram for an example of outlier explanation 830 is shown. In the illustration, outlier explanation 830 includes statistics about an identified outlier based on metrics 224. As shown, the explanation includes that the identified outlier exceeds the moving average line by 20% and the moving average boundary by 10%. The explanation includes that the identified outlier is also the highest observed spike in a six-month time period and a similar identified outlier was observed outside an eight-month period. Outlier explanation 830, in various embodiments, may include additional statistics and metadata regarding the identified outlier. Outlier explanation 830 provides users with a contextual understanding of the outlier and thus facilitates informed decision making.

Turning now to FIG. 8C, a diagram for an example of trend explanation 840 is shown. In the illustration, trend explanation 840 includes statistics about an identified trend based on trend identification criteria 720. As shown, the explanation includes that the trend is monotonically increasing in the last two days and has potential to cause an outlier. The explanation includes that the trend includes a data point that exceeds different moving average boundaries. Trend explanation 840, in various embodiments, may include additional statistics and metadata regarding the identified trend.

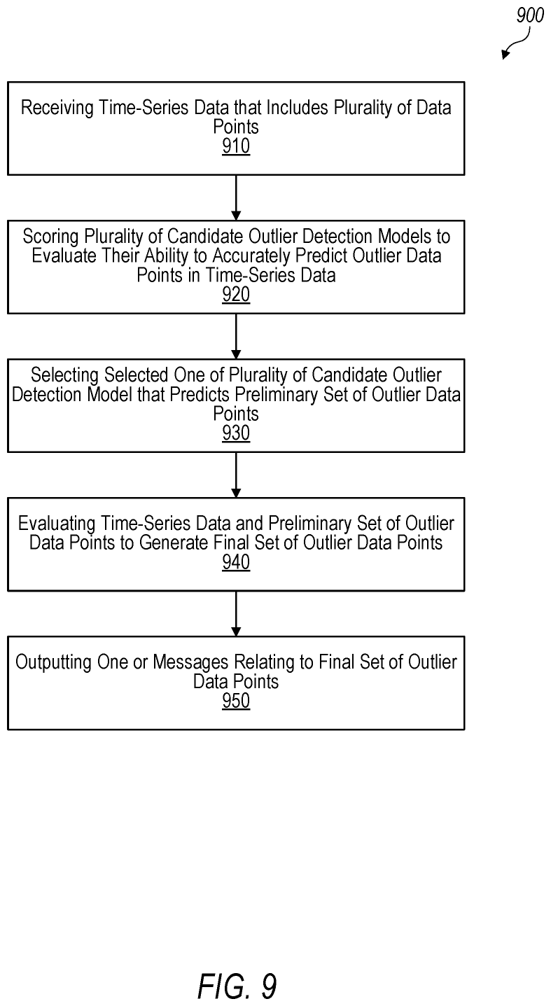

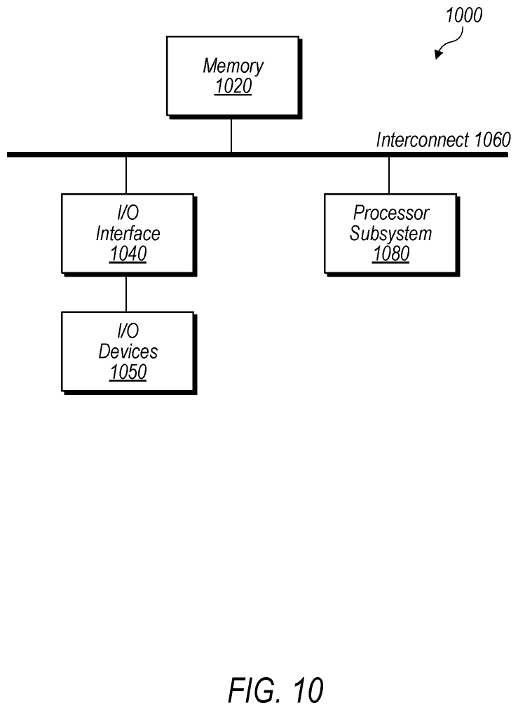

Turning now to FIG. 9, a flow diagram of a method 900 is shown. Method 900 is one embodiment of a method performed by a computer system (e.g., time-series analysis engine 110) to predict outliers (e.g., final set of outlier data points 145) in time-series data (time-series data 115). Method 900 may be performed by executing a set of program instructions stored on a non-transitory computer-readable medium.

Method 900 begins in step 910 with the computer system receiving time-series data (e.g., time-series data 115) that includes a plurality of data points. In step 920, the computer system (e.g., model selection engine 130) scores, using a first scoring function (e.g., scoring function module 222), a plurality of candidate outlier detection models (e.g., candidate outlier detection model 120) to evaluate their ability to accurately predict outlier data points (e.g., model predicted outliers 234) in the time-series data. The first scoring function is based on a first plurality of criteria (e.g., metrics 224) that are measured using aggregated results of the plurality of data points.

In step 930, the computer system selects, based on results of the scoring (e.g., results 230), a selected one of the plurality of candidate outlier detection model that predicts a preliminary set of outlier data points (e.g., preliminary set of outlier data points 135). The plurality of outlier detection models includes a first outlier detection model, a second outlier detection model, and a third outlier detection model that is an ensemble model based on the first and second outlier detection models.

In step 940, the computer system (e.g., time-series evaluation engine 140) evaluates the time-series data and the preliminary set of outlier data points to generate a final set of outlier data points (e.g., final set of outlier data points 145). The evaluation includes using a second scoring function (e.g., strong/weak scoring module 412) to score the preliminary set of outlier data points, identifying any ones of the preliminary set of outlier data points indicated by the second scoring function as weak outliers (e.g., weak outlier data point 416), and removing any identified weak outliers from the preliminary set of outlier data points. The second scoring function is based on a second plurality of criteria (e.g., metrics 413) that are measured using properties of single points within the plurality of data points. The evaluation further includes using a set of rules to evaluate non-outliers in the time-series data to determine any missing outlier data points (e.g., missing outlier module 430) and including any determined missing outlier data points (e.g., missing strong outlier data points 440) in the final set of outlier data points. The computer system selects a filtering rule (e.g., keyword filtering module 470) based on a description of a metric associated with the time-series data and removes one of the preliminary set of outlier data points based on the selected filtering rule. The computer system identifies trend anomalies (e.g., trend forewarning module 480) in the time-series data with the potential to result in outlier data points.

In step 950, the computer system outputs one or messages (e.g., message engine 150) relating to the final set of outlier data points. The one or more messages (e.g., messages 160) includes at least one message providing an explanation of why a particular outlier data point within the final set of outlier data points was identified (e.g., outlier explanation 830). The one or more messages includes at least one message providing an explanation of why a particular trend was identified (e.g., trend explanation 840).

Various techniques described herein, may be performed by one or more computer programs. The term “program” is to be construed broadly to cover a sequence of instructions in a programming language that a computing device can execute or interpret. These programs may be written in any suitable computer language, including lower-level languages such as assembly and higher-level languages such as Python.

Program instructions may be stored on a “non-transitory, computer-readable storage medium” or a “non-transitory, computer-readable medium.” The storage of program instructions on such media permits execution of the program instructions by a computer system. These are broad terms intended to cover any type of computer memory or storage device that is capable of storing program instructions. The term “non-transitory,” as is understood, refers to a tangible medium. Note that the program instructions may be stored on the medium in various formats (source code, compiled code, etc.).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM. SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

Note that in some cases, program instructions may be stored on a storage medium but not enabled to execute in a particular computing environment. For example, a particular computing environment (e.g., a first computer system) may have a parameter set that disables program instructions that are nonetheless resident on a storage medium of the first computer system. The recitation that these stored program instructions are “capable” of being executed is intended to account for and cover this possibility. Stated another way, program instructions stored on a computer-readable medium can be said to “executable” to perform certain functionality, whether or not current software configuration parameters permit such execution. Executability means that when and if the instructions are executed, they perform the functionality in question.

Similarly, systems that implement the methods described with respect to any of the disclosed techniques are also contemplated. Such a system may be implemented on a computer server system in some embodiments (e.g., an authentication server). Such a server may include a processor subsystem that is coupled to a system memory and I/O interfaces(s) via an interconnect (e.g., a system bus). The I/O interface(s) may be coupled to a computer network for receiving and sending communications.

The processor subsystem may include one or more processors or processing units. In various embodiments, multiple instances of the processor subsystem may be coupled to the interconnect. Processor subsystem (or each processor sub-unit) may contain a cache or other form of on-board memory.

System memory is usable store program instructions executable by the processor subsystem to cause the server system perform various operations described herein. System memory may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in the server system is not limited to primary storage. Rather, the server system may also include other forms of storage such as cache memory in processor subsystem and secondary storage within the I/O Devices (e.g., a hard drive, storage array, etc.). In some embodiments, these other forms of storage may also store program instructions executable by the processor subsystem. In some embodiments, program instructions that when executed implement embedding engine 120 may be included/stored within the system memory.

The I/O interfaces may be any of various types of interfaces configured to couple to and communicate with other devices, according to various embodiments. The I/O interfaces may be coupled to one or more I/O devices via one or more corresponding buses or other interfaces. Examples of I/O devices include storage devices (hard drive, optical drive, removable flash drive, storage array, SAN, or their associated controller), network interface devices (e.g., to a local or wide-area network), or other devices (e.g., graphics, user interface devices, etc.). Thus, the server system may thus be coupled to a network via a network interface device in order to receive authentication requests and provide responses thereto.

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112 (f) for that claim element. Should Applicant wish to invoke Section 112 (f) during prosecution of a United States patent application based on this disclosure, it will recite claim elements using the “means for” [performing a function] construct.

What is claimed is:

1. A method, comprising:
receiving, at a computer system, time-series data that includes a plurality of data points;
scoring, by the computer system using a first scoring function, a plurality of candidate outlier detection models to evaluate their ability to accurately predict outlier data points in the time-series data;
selecting, by the computer system based on results of the scoring, a selected one of the plurality of candidate outlier detection model that predicts a preliminary set of outlier data points;
evaluating, by the computer system, the time-series data and the preliminary set of outlier data points to generate a final set of outlier data points;
outputting, by the computer system, one or messages relating to the final set of outlier data points.

2. The method of claim 1, wherein the first scoring function is based on a first plurality of criteria that are measured using aggregated results of the plurality of data points.

3. The method of claim 1, wherein the evaluating includes:
using a second scoring function to score the preliminary set of outlier data points;
identifying any ones of the preliminary set of outlier data points indicated by the second scoring function as weak outliers; and
removing any identified weak outliers from the preliminary set of outlier data points.

4. The method of claim 3, wherein the second scoring function is based on a second plurality of criteria that are measured using properties of single points within the plurality of data points.

5. The method of claim 3, wherein the evaluating further includes:
using a set of rules to evaluate non-outliers in the time-series data to determine any missing outlier data points; and
including any determined missing outlier data points in the final set of outlier data points.

6. The method of claim 1, further comprising:
selecting a filtering rule based on a description of a metric associated with the time-series data;
removing one of the preliminary set of outlier data points based on the selected filtering rule.

7. The method of claim 1, wherein the one or more messages includes at least one message providing an explanation of why a particular outlier data point within the final set of outlier data points was identified.

8. The method of claim 1, further comprising:
identifying trend anomalies in the time-series data with the potential to result in outlier data points.

9. The method of claim 8, wherein the one or more messages includes at least one message providing an explanation of why a particular trend was identified.

10. The method of claim 1, wherein the plurality of outlier detection models includes a first outlier detection model, a second outlier detection model, and a third outlier detection model that is an ensemble model based on the first and second outlier detection models.

11. A non-transitory, computer-readable storage medium storing program instructions executable by a computer system to perform operations comprising:
receiving, at a computer system, time-series data that includes a plurality of data points;
scoring, by the computer system, a plurality of candidate outlier detection models to evaluate their ability to accurately predict outlier data points in the time-series data;
selecting, by the computer system based on results of the scoring, a selected one of the plurality of candidate outlier detection model that predicts a preliminary set of outlier data points;
evaluating, by the computer system, the time-series data and the particular set of outlier data points to generate a final set of outlier data points;
outputting, by the computer system, one or messages relating to the final set of outlier data points.

12. The non-transitory, computer-readable storage medium of claim 11, wherein the scoring is performed using a scoring function that is based on a first plurality of criteria that are measured using aggregated results of the plurality of data points.

13. The non-transitory, computer-readable storage medium of claim 12, wherein the evaluating includes removing weak outliers and adding missing outliers based on pluralities of criteria that are measured using properties of single points within the plurality of data points.

14. The non-transitory, computer-readable storage medium of claim 11, wherein the evaluating further includes:
selecting a filtering rule based on a description of a metric associated with the time-series data;
removing one of the preliminary set of outlier data points based on the selected filtering rule.

15. The non-transitory, computer-readable storage medium of claim 11, wherein the one or more messages includes at least one message providing an explanation of why a particular outlier data point within the final set of outlier data points was identified.

16. A method, comprising:
receiving, at a computer system, time-series data that includes a plurality of data points, none of which are labeled as outlier data points;
scoring, by the computer system using a first scoring function, a plurality of candidate outlier detection models to evaluate their ability to accurately predict outlier data points in the time-series data, wherein the first scoring function is based on a first plurality of criteria that are measured using aggregated results of the plurality of data points;
selecting, by the computer system based on results of the scoring, a selected one of the plurality of candidate outlier detection model that predicts a preliminary set of outlier data points;
evaluating, by the computer system, the time-series data and the particular set of outlier data points to generate a final set of outlier data points, wherein the evaluating includes: identifying, based on a second scoring function, weak outliers in the preliminary set of outlier data points, wherein the second scoring function is based on a second plurality of criteria that are measured using properties of single points within the plurality of data points;
removing any identified weak outliers from the preliminary set of outlier data points;
outputting, by the computer system, one or messages relating to the final set of outlier data points.

17. The method of claim 16, wherein the first plurality of criteria includes at least two criteria from the following types of criteria:
a first criterion that measures proportions of detected outliers outside different moving average windows for the time-series data;
a second criterion that measures a proportion of outliers belonging to spikes;
a third criterion that measures distances between outliers and different moving average trends;
a fourth criterion that measures lengths of extreme periods for outliers;
a fifth criterion that measures lengths of extreme periods for non-outliers; and
a sixth criterion that measures a number of similar outliers in proximity to one another.

18. The method of claim 16, wherein the evaluating further includes: determining, based on a set of rules, whether any of the plurality of data points not within the preliminary set of outlier data points, constitutes a missing outlier, wherein the set of rules is based on a third plurality of criteria that are measured using properties of single points within the plurality of data points; and
adding any determined missing outliers to the preliminary set of outlier data points.

19. The method of claim 17, wherein the one or messages include at least one message explaining why one of the final set of outlier data points was identified as an outlier.

20. The method of claim 19, further comprising:
identifying, from the plurality of data points, a trend that has not given rise to an outlier data point;
outputting, an indication of the identified trend, and a narrative explaining why the trend was identified.
